(19) United States
(12) Patent Application Publication
(10) Pub. No.: US 2018/0066797 A1
(43) Pub. Date: Mar. 8, 2018

(54) FIBER REINFORCED POLYMER MATRIX COMPOSITE STRUCTURE AND HIGH PRESSURE CONTAINER, AND METHOD OF MANUFACTURING THE SAME

(71) Applicants: Toyota Jidosha Kabushiki Kaisha, Toyota-shi Aichi-ken (JP); National Institute for Materials Science, Tsukuba-Shi (JP)

(72) Inventors: Naoki Nakamura, Sunto-gun Shizuoka-ken (JP); Masaki Ando, Gotenba-shi Shizuoka-shi (JP); Kimiyoshi Naito, Tsukuba-shi Ibaraki-ken (JP)

(21) Appl. No.: 15/694,187

(22) Filed: Sep. 1, 2017

(30) Foreign Application Priority Data
Sep. 5, 2016 (JP) 2016-172517

(51) Int. Cl. F17C 1/06; B32B 37/06; B32B 37/14

(52) U.S. Cl. CPC F17C 1/06; B32B 37/06; B32B 37/14; B32B 2439/40; B32B 2262/101; B32B 2262/106; F17C 2260/011; F17C 2201/0109; F17C 2203/0604; F17C 2203/0663; F17C 2203/0673; F17C 2209/2154; F17C 2221/012; B32B 2305/076

(57) ABSTRACT

A fiber reinforced polymer matrix composite structure includes a glass fiber layer and a carbon fiber layer in a cured resin. The glass fiber layer and the carbon fiber layer are laminated and present in a thickness direction of the structure. Two outermost layers of the fiber reinforced polymer matrix composite structure including the glass fiber layer and the carbon fiber layer are both the glass fiber layer. In the structure, a volume fraction of carbon fibers with respect to a total volume of glass fibers and carbon fibers is 0.67 or more.

### CROSS-REFERENCE TO RELATED APPLICATIONS

This application claims priority to Japanese Patent Application No. 2016-172517 filed on Sep. 5, 2016, which is incorporated herein by reference in its entirety including the specification, drawings and abstract.

### BACKGROUND

### 1. Technical Field

The present disclosure relates to a fiber reinforced polymer matrix composite structure and a high pressure container, and a manufacturing method therefor.

### 2. Description of Related Art

As components for a high pressure container needing a high strength, an automobile structural component, and the like, a reinforced polymer matrix composite structure obtained by heating and curing a laminate of prepregs in which a resin is impregnated into a fibrous reinforcement body is known.

For example, in Japanese Patent Application Publication No. 5-147169 (JP 5-147169 A), a laminate which includes a thermoplastic resin, and a woven fabric or a reinforcement body arranged in one direction and in which layers between a sheet prepreg containing a reinforcement body at 40 to 85 weight % and a molding component including a thermoplastic resin sheet are firmly bonded is disclosed.

Referring to the example in JP 5-147169 A, it is described that, when a carbon fiber is used as a reinforcement body, a component having a higher breaking load is obtained compared to when a glass fiber is used.

Japanese Patent Application Publication No. 2009-6494 (JP 2009-6494 A) describes a method of manufacturing a fiber reinforced polymer matrix composite structure including inserting an insert component having a higher coefficient of linear expansion than a fiber reinforced polymer matrix layer into the fiber reinforced polymer matrix layer including a thermosetting resin matrix. The method of manufacturing a fiber reinforced polymer matrix composite structure includes a process in which an insert component is disposed in a prepreg component that forms the fiber reinforced polymer matrix layer; a pre-heating process in which the fiber reinforced polymer matrix composite structure is heated to a temperature that is lower than a temperature at which a thermosetting resin in the prepreg component is completely cured, and a main heating process in which the fiber reinforced polymer matrix composite structure is heated to the temperature at which the thermosetting resin is completely cured after heating in the pre-heating process. As a preferable aspect of the structure, a case in which the fiber reinforced polymer matrix layer is a layer including a carbon fiber reinforced plastic, and the insert component is made of a glass fiber reinforced plastic is described.

It is described in JP 2009-6494 A that the above structure has an effect of preventing layers and interfaces between components from being separated during molding.

In addition, Japanese Patent Application Publication No. 2009-23163 (JP 2009-23163 A) describes a fiber reinforced polymer matrix surface component which includes at least a first fiber bundle group having a planar shape in which a plurality of carbon fiber bundles formed by bundling carbon fibers are arranged in conditions with the same orientations and a second fiber bundle group having a planar shape in which a plurality of carbon fiber bundles oriented in a different direction from the first fiber bundle group are arranged in conditions with the same orientations. While at least the first and second fiber bundle groups are laminated, they are integrally formed in a cured resin to form a carbon fiber reinforced polymer matrix substrate. A glass fiber reinforced polymer matrix surface component in which a cloth component of glass fibers and a cured resin are integrally formed is fixed to a surface of the carbon fiber reinforced polymer matrix substrate.

It is described in JP 2009-23163 A that, if the above resin surface component is used, it is possible to completely prevent the occurrence of burrs when a punching process is performed and it is possible to increase production efficiency while desired extension is ensured.

Here, in “The strength of hybrid glass/carbon fibre composites Part. 1 Failure strain enhancement and failure mode,” J. Mater. Sci., 16(1981), 2233, mathematical consideration for predicting a strength of a component including two types of reinforcement body is described.

### SUMMARY

When only carbon fibers are used as a reinforcement body, a high strength and modulus can be obtained, but manufacturing costs become excessively high. On the other hand, when only glass fibers are used as a reinforcement body, a desired high strength and modulus are not obtained. Alternatively, when carbon fibers and glass fibers are used in combination, a desired high strength is not immediately obtained according to the combination, which is described in “The strength of hybrid glass/carbon fibre composites Part. 1 Failure strain enhancement and failure mode,” J. Mater. Sci., 16(1981), 2233.

The present disclosure provides a fiber reinforced polymer matrix composite structure and a method of manufacturing the same which are excellent in balance between costs, and a strength and a modulus.

The present disclosure provides a high pressure container that is obtained using the above structure and has a suitable modulus and a high strength, and a method of manufacturing the same.

A first aspect of the present disclosure relates to a fiber reinforced polymer matrix composite structure including a glass fiber layer and a carbon fiber layer in a cured resin. The glass fiber layer and the carbon fiber layer are laminated and present in a thickness direction of the structure. Two outermost layers of the fiber reinforced polymer matrix composite structure including the glass fiber layer and the carbon fiber layer are both the glass fiber layer. In the structure, a volume fraction of carbon fibers with respect to a total volume of glass fibers and carbon fibers is 0.67 or more.

A second aspect of the present disclosure relates to a high pressure container having the above fiber reinforced polymer matrix composite structure on an outer circumferential surface of a liner.

A third aspect of the present disclosure relates to a method of manufacturing the above fiber reinforced polymer matrix composite structure including: laminating a first sheet prepreg containing glass fibers and a second sheet prepreg containing carbon fibers to prepare a prepreg laminate; and heating the prepreg laminate. In this manufacturing method, two outermost layers in the prepreg laminate are both the first sheet prepreg, and a volume fraction of carbon fibers with respect to a total volume of glass fibers and carbon fibers is 0.67 or more in the prepreg laminate.

A fourth aspect of the present disclosure relates to a method of manufacturing the above high pressure container including sheet-winding a first sheet prepreg containing glass fibers and a second sheet prepreg containing carbon fibers on an outer circumference of the liner to form a prepreg laminate on the outer circumference of the liner; helically winding carbon fibers on the prepreg laminate to obtain a high pressure container precursor; and heating the high pressure container precursor. In this manufacturing method, two outermost layers in the prepreg laminate are both the first sheet prepreg, and a volume fraction of carbon fibers with respect to a total volume of glass fibers and carbon fibers is 0.67 or more in the prepreg laminate.

According to the present disclosure, there are provided a reinforced polymer matrix composite structure which is excellent in balance between costs, and a strength and a modulus, a high pressure container that is obtained using the structure and has a suitable modulus and a high strength, and a method of manufacturing the same.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows graphs showing stress and strain curves obtained in Examples 1 to 3, and Comparative Examples 3 and 9 in comparison with Comparative Examples 1 and 2;

FIG. 2 shows pictures of states of samples that break after a tensile test in Examples 1 to 3 and Comparative Examples 1 to 3 and 9;

FIG. 3 is a graph showing a relationship between predicted values (a straight line) and measured values (plotted points) of a tensile modulus, and the horizontal axis represents a hybrid ratio (a volume fraction of carbon fibers with respect to a total volume of glass fibers and carbon fibers, hereinafter the same);

FIG. 4 is a graph showing a relationship between predicted values (straight lines) and measured values (plotted points) of a tensile strength, and the horizontal axis represents a hybrid ratio;

FIG. 5 is a graph showing predicted strength values when the horizontal axis represents a hybrid ratio μ;

FIG. 6 is a schematic cross-sectional view for describing a structure of a high pressure container of the present embodiment;

FIG. 7A is a schematic diagram for describing a method of manufacturing a high pressure container of the present embodiment;

FIG. 7B is a schematic diagram for describing a method of manufacturing a high pressure container of the present embodiment;

FIG. 7C is a schematic diagram for describing a method of manufacturing a high pressure container of the present embodiment; and

FIG. 8 is a schematic cross-sectional view for describing a typical structure of a fiber reinforced polymer matrix composite structure of the present embodiment.

### DETAILED DESCRIPTION OF EMBODIMENTS

<Fiber reinforced polymer matrix composite structure> A reinforced polymer matrix composite structure of the present embodiment is a fiber reinforced polymer matrix composite structure including a glass fiber layer and a carbon fiber layer in a cured resin. The glass fiber layer and the carbon fiber layer are laminated in a thickness direction of the structure. Two outermost layers of the fiber reinforced polymer matrix composite structure including the glass fiber layer and the carbon fiber layer are both the glass fiber layer. Therefore, in the structure, a volume fraction of carbon fibers with respect to a total volume of glass fibers and carbon fibers is 0.67 or more.

As a form in which glass fiber layers and carbon fiber layers are laminated in a thickness direction of the reinforced polymer matrix composite structure, two adjacent layers may be laminated in contact with each other or two adjacent layers may be laminated with a significant interval therebetween without being in contact with each other. In one structure, two layers in contact with each other and two layers not in contact with each other may be mixed.

In the reinforced polymer matrix composite structure of the present embodiment, when the two outermost layers among glass fiber layers and carbon fiber layers are both a glass fiber layer and a volume fraction of carbon fibers with respect to a total volume of glass fibers and carbon fibers is 0.67 or more, the resulting structure has a suitable modulus and a strength thereof can be extremely high.

Here, the outermost layers are layers closest to both surfaces of the structure among glass fiber layers and carbon fiber layers that are laminated in the fiber reinforced polymer matrix composite structure.

In the fiber reinforced polymer matrix composite structure of the present embodiment, all of the inner layers other than the two outermost layers among glass fiber layers and carbon fiber layers in the structure may be a carbon fiber layer or a mixture of glass fiber layers and carbon fiber layers.

When a volume fraction of carbon fibers with respect to a total volume of glass fibers forming a glass fiber layer and carbon fibers forming a carbon fiber layer included in the fiber reinforced polymer matrix composite structure of the present embodiment is higher, the resulting structure has a higher strength and a more appropriate value of a modulus. However, in order to prevent manufacturing costs of the structure from excessively increasing, a volume fraction of carbon fibers with respect to a total volume of glass fibers and carbon fibers is set to 0.843 or less in some embodiments.

A volume fraction of carbon fibers with respect to a total volume of glass fibers and carbon fibers may be 0.70 or more, 0.72 or more, or 0.75 or more, or may be 0.82 or less, 0.80 or less, or 0.78 or less.

A total number (a total number of sheets) of glass fiber layers and carbon fiber layers included in the fiber reinforced polymer matrix composite structure of the present embodiment is arbitrary. However, in order to obtain a balance between a high strength and low costs and in order to prevent the thickness of the structure from excessively increasing, the total number may be, for example, 6 sheets or more, 7 sheets or more, or 8 sheets or more, or may be 12 sheets or less, 11 sheets or less, or 10 sheets or less.

In the fiber reinforced polymer matrix composite structure of the present embodiment, an orientation of fibers between two adjacent layers among glass fiber layers and carbon fiber layers is arbitrary. In some embodiments, a superposition is 0°/0° when two adjacent layers are a fiber tow, and a superposition is 0°/90° when two adjacent layers are a fiber cloth, in order to increase a strength as much as possible and obtain an appropriate value of a modulus.

In some embodiments, the shape of the fiber reinforced polymer matrix composite structure of the present embodiment is a plate shape.

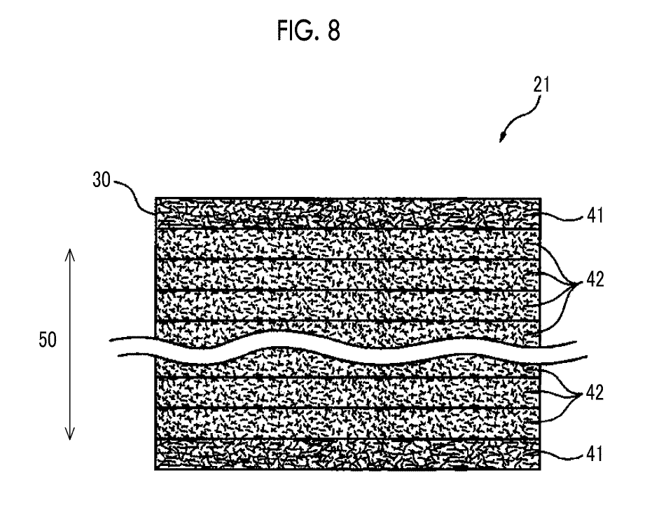

FIG. 8 is a schematic cross-sectional view of a typical example of the fiber reinforced polymer matrix composite structure of the present embodiment.

A fiber reinforced polymer matrix composite structure 21 in FIG. 8 includes glass fiber layers 41 and carbon fiber layers 42 in a cured resin 30. The glass fiber layers 41 and the carbon fiber layers 42 are laminated in a thickness direction 50 of the structure 21. Among the glass fiber layers 41 and the carbon fiber layers 42, the two outermost layers are both the glass fiber layer 41. In the fiber reinforced polymer matrix composite structure 21 in FIG. 8, among the glass fiber layers 41 and the carbon fiber layers 42 in the structure 21, all of the inner layers other than the two outermost layers may be the carbon fiber layer 42. However, the fiber reinforced polymer matrix composite structure of the present embodiment is not limited thereto.

The size of the fiber reinforced polymer matrix composite structure of the present embodiment (the size of the largest surface of the plate structure) is arbitrary according to applications thereof. The thickness of the structure may be, for example, 1.5 mm or more, 1.9 mm or more, or 2.9 mm or more, or may be 3.1 mm or less, 2.1 mm or less, or 1.6 min or less.

The breaking strain of the fiber reinforced polymer matrix composite structure of the present embodiment may be, for example, 1.13% or more, 1.15% or more, or 1.17% or more, or may be 1.44% or less, 1.34% or less, or 1.30% or less.

The tensile strength of the fiber reinforced polymer matrix composite structure of the present embodiment may be, for example, 0.48 GPa or more, 0.52 GPa or more, or 0.54 GPa or more, or may be 0.62 GPa or less, 0.61 GPa or less, or 0.59 GPa or less.

The tensile modulus of the fiber reinforced polymer matrix composite structure of the present embodiment may be, for example, 38 GPa or more, 42 GPa or more, or 44 GPa or more, or may be 42 GPa or less, 46 GPa or less, or 48 GPa or less.

The above breaking strain, tensile strength, and tensile modulus can be measured according to methods described in the following examples.

The glass fiber layer, the carbon fiber layer, and the cured resin of the fiber reinforced polymer matrix composite structure of the present embodiment will be described below in that order.

[Glass fiber layer] The fiber reinforced polymer matrix composite structure of the present embodiment includes a glass fiber layer. The glass fiber layer is formed of glass fibers. In some embodiments, the glass fiber layer is a layer that is derived from a glass fiber prepreg (for example, a glass fiber prepreg formed of glass fiber cloth and a resin) and remains in the fiber reinforced polymer matrix composite structure of the present embodiment even after a prepreg laminate to be described below is heated.

The glass fibers may have, for example, a tensile modulus E_{f} of about 75 GPa and a tensile strength σ_{f} of about 3.2 GPa.

As a form of the glass fiber layer, a layer including a fiber tow in which the above glass fibers are oriented in one direction or a layer including fiber cloth in which glass fibers are in a woven state may be used. In some embodiments, a cloth component layer includes fiber cloth in a woven state.

[Carbon fiber layer] The fiber reinforced polymer matrix composite structure of the present embodiment includes a carbon fiber layer. The carbon fiber layer includes carbon fibers. In some embodiments, the carbon fiber layer is a layer that is derived from a carbon fiber prepreg (for example, a carbon fiber prepreg formed of carbon fiber cloth and a resin) and remains in the fiber reinforced polymer matrix composite structure of the present embodiment even after a prepreg laminate to be described below is heated.

The carbon fibers may have, for example, a tensile modulus E_{f} of about 230 GPa and a tensile strength σ_{f} of about 3.53 GPa.

As a form of the carbon fiber layer, a layer including the above carbon fiber tow or a cloth component layer including carbon fiber cloth may be used. In some embodiments, the carbon fiber layer is the cloth component layer.

[Cured resin] The cured resin in the fiber reinforced polymer matrix composite structure of the present embodiment may be a cured thermosetting resin product. As the cured resin, for example, a thermosetting epoxy resin, phenolic resin, polyimide resin, cyanate resin, unsaturated polyester resin, or vinyl ester resin product may be exemplified, and one or more selected from among these may be used. In some embodiments, the cured resin is a thermosetting epoxy resin product.

A content of the cured resin in the fiber reinforced polymer matrix composite structure of the present embodiment may be, for example, 40 mass % or more and 44 mass % or less.

<Application of fiber reinforced polymer matrix composite structure> The fiber reinforced polymer matrix composite structure of the present embodiment can be applied to various fields in which a plate component having a high strength and a suitable modulus is necessary.

Application examples of the fiber reinforced polymer matrix composite structure of the present embodiment may include, specifically, for example, a high pressure container in addition to an automobile hood, an impact beam, a platform, a roof, a propeller shaft, a trunk lid, a diffuser, a rear spoiler, and the like.

The fiber reinforced polymer matrix composite structure of the present embodiment is excellent in balance between manufacturing costs, and a strength and a modulus, and is particularly suitable for application as a reinforced layer component of a high pressure container.

[High pressure container] The high pressure container of the present embodiment includes the fiber reinforced polymer matrix composite structure of the present embodiment on an outer circumferential surface of a liner. An aspect of the high pressure container of the present embodiment will be described below with reference to the drawings.

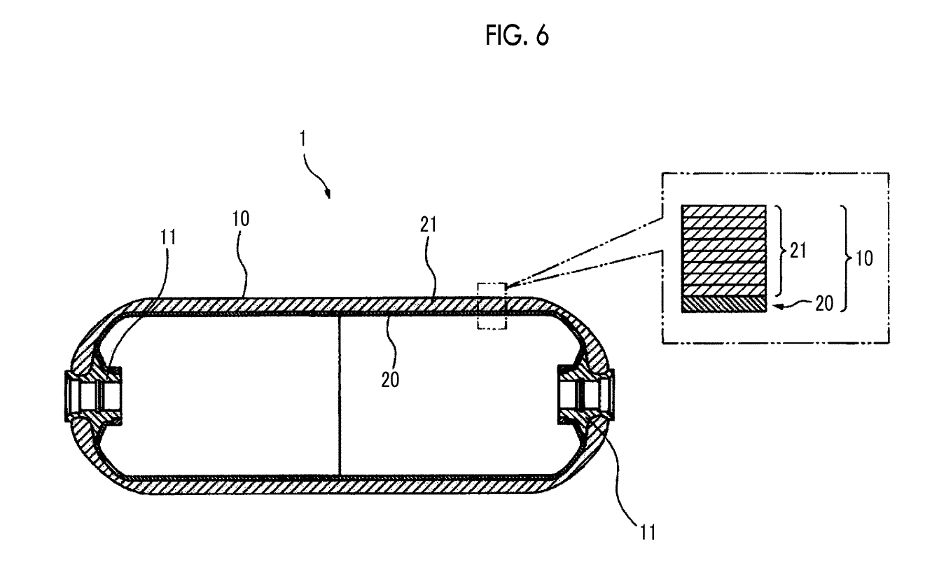

A high pressure container 1 in FIG. 6 includes, for example, a cylindrical container body 10 whose both ends have a substantially hemispherical shape, a base 11 disposed at an end of the container body 10 in a longitudinal direction, and the like. The container body 10 includes a sealed liner 20 serving as an inner layer and a layer including the fiber reinforced polymer matrix composite structure 21 of the present embodiment surrounding the outer circumferential surface of the liner 20. A carbon fiber layer may be additionally provided on the outer circumferential surface of the layer including the fiber reinforced polymer matrix composite structure 21.

In the high pressure container 1 in FIG. 6, the layer of the fiber reinforced polymer matrix composite structure 21 functions as a reinforcing layer. The high pressure container of the present embodiment including a layer having the fiber reinforced polymer matrix composite structure 21 as the reinforcing layer has a high pressure resistance, and is extremely lightweight and inexpensive. The high pressure container of the present embodiment can be suitably applied as, for example, a gas storage tank. In some embodiments, the high pressure container is applied as a hydrogen tank.

<Method of manufacturing fiber reinforced polymer matrix composite structure> The fiber reinforced polymer matrix composite structure of the present embodiment can be manufactured by, for example, the following method: a method of manufacturing a fiber reinforced polymer matrix composite structure including laminating a first sheet prepreg containing glass fibers and a second sheet prepreg containing carbon fibers to prepare a prepreg laminate and heating the prepreg laminate. In the structure, two outermost layers in the prepreg laminate are both the first sheet prepreg. In the prepreg laminate, a volume fraction of carbon fibers with respect to a total volume of glass fibers and carbon fibers is 0.67 or more.

[Prepreg laminate] A prepreg laminate, which is a precursor for manufacturing the fiber reinforced polymer matrix composite structure of the present embodiment, is a laminate of a first sheet prepreg containing glass fibers and a second sheet prepreg containing carbon fibers.

In some embodiments, the first and second sheet prepregs can be formed by impregnating a thermosetting resin into a tow or cloth component including glass fibers or a tow or cloth component including carbon fibers.

(First sheet prepreg) The first sheet prepreg in the present embodiment includes glass fibers, and in some embodiments, a thermosetting resin is impregnated into the glass fibers.

For the glass fibers in the first sheet prepreg, as glass fibers included in the fiber reinforced polymer matrix composite structure of the present embodiment, glass fibers having the above physical properties can be appropriately selected and used according to desired performance of a target fiber reinforced polymer matrix composite structure.

In some embodiments, the glass fibers in the first sheet prepreg are layered. As a form of the layered glass fibers, according to the form of the glass fiber layers in a desired fiber reinforced polymer matrix composite structure, glass fibers may be appropriately selected from among the above forms.

The content of glass fibers in the first sheet prepreg may be, for example, 290 g/m² as a fiber areal weight, and, for example, 43.4 volume % as a fiber volume fraction.

The thermosetting resin in the first sheet prepreg can be appropriately selected and used from among the above forms according to a type of a cured resin included in the desired fiber reinforced polymer matrix composite structure. In some embodiments, the thermosetting resin is an epoxy resin. The content of the thermosetting resin in the first sheet prepreg may be, for example, 40 mass %.

The tensile modulus and the tensile strength of the first sheet prepreg are arbitrary.

The tensile modulus of the first sheet prepreg may be, for example, 19 GPa or more and 23 GPa or less. The tensile strength of the first sheet prepreg may be, for example, 0.42 GPa or more and 0.48 GPa or less.

The thickness of the first sheet prepreg may be, for example, 0.25 mm or more and 0.31 mm or less.

(Second sheet prepreg) The second sheet prepreg in the present embodiment includes carbon fibers. In some embodiments, a thermosetting resin is impregnated into the carbon fibers.

In selection of carbon fibers in the second sheet prepreg and a form in which carbon fibers are layered, selection may be appropriately performed from among the above forms according to the physical properties and the form of the carbon fiber layer in a desired fiber reinforced polymer matrix composite structure.

The content of carbon fibers in the second sheet prepreg may be, for example, 200 g/m² as a fiber areal weight and, for example, 46.5 volume % as a fiber volume fraction.

As the thermosetting resin in the second sheet prepreg, the same thermosetting resin as in the above first sheet prepreg can be used. The content of the thermosetting resin in the second sheet prepreg may be, for example, 44 mass %.

The tensile modulus and the tensile strength of the second sheet prepreg are arbitrary.

The tensile modulus of the second sheet prepreg may be, for example, 52 GPa or more and 56 GPa or less. The tensile strength of the second sheet prepreg may be, for example, 0.59 GPa or more and 0.69 GPa or less.

The thickness of the second sheet prepreg may be, for example, 0.23 mm or more and/or 0.26 mm or less.

(Prepreg laminate) In the method of manufacturing a fiber reinforced polymer matrix composite structure of the present embodiment, as described above, a first sheet prepreg containing glass fibers and a second sheet prepreg containing carbon fibers are laminated to prepare a prepreg laminate. Here, two outermost layers in the prepreg laminate are both the first sheet prepreg. It is important to adjust a volume fraction of carbon fibers with respect to a total volume of glass fibers and carbon fibers to 0.67 or more in the prepreg laminate.

In some embodiments, when the first sheet prepreg and the second sheet prepreg are laminated, adjustments are appropriately preformed so that an orientation of fibers between adjacent layers matches an orientation of fiber layers in the desired fiber reinforced polymer matrix composite structure.

A total number of prepregs in the prepreg laminate may be, for example, 6 sheets or more, 7 sheets or more, or 8 sheets or more, or may be 12 sheets or less, 11 sheets or less, or 10 sheets or less.

(Heating) In the method of manufacturing a fiber reinforced polymer matrix composite structure of the present embodiment, next, the prepreg laminate described above is heated. The heating may be performed under pressure.

The above heating may be performed at a temperature of, for example, 100° C. or higher, 110° C. or higher or 120° C. or higher, and 200° C. or lower, 150° C. or lower, or 135° C. or lower, and for a time of, for example, 1 hour or longer, 2 hours or longer, or 3 hours or longer, and for 12 hours or shorter, 10 hours or shorter, or 8 hours or shorter. The heating may be performed in one stage or multiple stages. In some embodiments, for example, heating is performed in two stages, at 120° C. for 4 hours and at 135° C. for 2 hours.

As a pressure during pressurizing, for example, a pressure of 0.490 MPa, may be exemplified.

<Method of manufacturing high pressure container> The high pressure container of the present embodiment includes a fiber reinforced polymer matrix composite structure of the present embodiment on the outer circumferential surface of the liner.

Accordingly, except that heating and curing of the prepreg laminate are performed on the outer circumferential surface of the liner, the high pressure container can be manufactured according to the above method of manufacturing the fiber reinforced polymer matrix composite structure or an appropriate modification thereof by those skilled in the art. In some embodiments, the following method is used.

The method of manufacturing a high pressure container includes sheet winding a first sheet prepreg containing glass fibers and a second sheet prepreg containing carbon fibers on an outer circumference of a liner to form a prepreg laminate on the outer circumference of the liner; helically winding carbon fibers on the prepreg laminate to obtain a high pressure container precursor; and heating the high pressure container precursor. In the method of manufacturing a high pressure container, two outermost layers in the prepreg laminate are both the first sheet prepreg and a volume fraction of carbon fibers with respect to a total volume of glass fibers and carbon fibers is 0.67 or more in the prepreg laminate.

The method of manufacturing a high pressure container of the present embodiment will be described below with reference to the drawings.

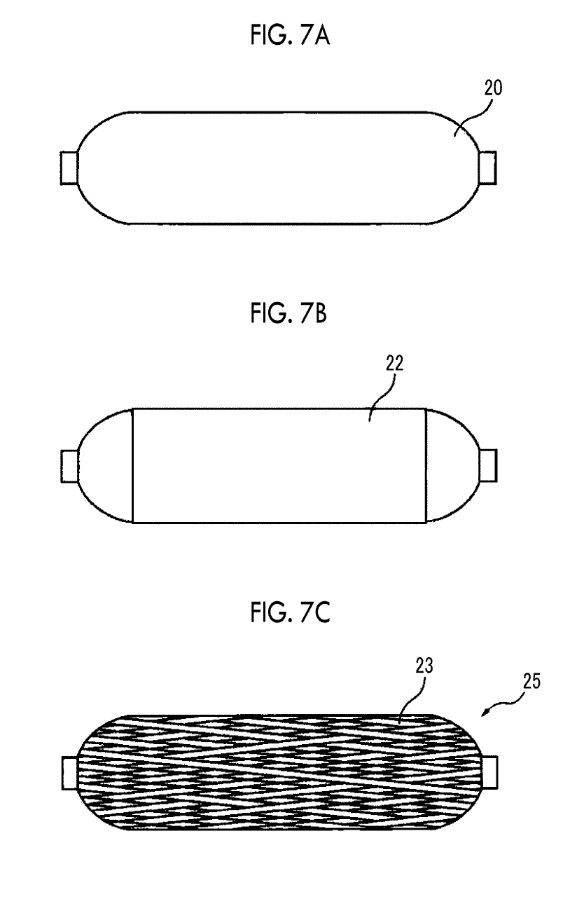

First, the liner 20 is prepared. The liner 20 may be made of a resin or a metal (FIG. 7A).

A first sheet prepreg containing glass fibers and a second sheet prepreg containing carbon fibers are sheet-wound on an outer circumference of the liner 20 to form a prepreg laminate 22 on the outer circumference of the liner 20 (FIG. 7B). Here, in the prepreg laminate 22, two outermost layers are both the above first sheet prepreg and a volume fraction of carbon fibers with respect to a total volume of glass fibers and carbon fibers is 0.67 or more in the prepreg laminate 22. That is, in the method of manufacturing a high pressure container of the present embodiment, the prepreg laminate 22 formed on the outer circumference of the liner is a prepreg laminate of the present embodiment.

When the prepreg laminate 22 is formed on the outer circumference of the liner 20, prepregs selected from the first sheet prepreg and the second sheet prepreg are sheet-wound for each one sheet or a plurality of sheets at a time in a predetermined order. As a result, the prepreg laminate 22 may be formed on the outer circumference of the liner 20, or the prepreg laminate 22 formed by laminating a first sheet prepreg and a second sheet prepreg in advance in a predetermined order may be sheet-wound on the outer circumference of the liner 20.

In some embodiments, when the first sheet prepreg and the second sheet prepreg are sheet-wound in order to form the prepreg laminate 22 on the outer circumference of the liner 20, a tension is adjusted when sheet winding is performed so that substantially the entire surface excluding substantially both hemispherical ends within the liner 20 is uniformly surrounded by the prepreg laminate 22 without wrinkles.

Next, additionally, carbon fibers 23 are helically wound on the outer circumference of the above prepreg laminate 22 to obtain a high pressure container precursor 25 (FIG. 7C).

The tensile modulus of the carbon fibers 23 used here may be, for example, 52 GPa or more and 56 GPa or less.

The carbon fibers 23 used here may be the same as the carbon fibers included in the second prepreg or may be different from the carbon fibers included in the second prepreg.

The carbon fibers 23 used here may be, for example, formed in a tape shape.

As helical winding, low angle helical winding in which an angle between a lengthwise direction of the carbon fibers 23 and a long axis direction of the liner 20 is 45° or less and high angle helical winding in which the angle exceeds 45° may be used. In FIG. 7C, the carbon fibers 23 are wound on the prepreg laminate 22 according to low angle helical winding.

Then, the high pressure container precursor 25 including the sheet-wound prepreg laminate 22 and the helically wound carbon fibers 23 on the outer circumferential surface of the liner 20 is then subjected to heating.

The heating may be performed at a temperature of, for example, 100° C. or higher, 110° C. or higher, or 120° C. or higher, and 200° C. or lower, 150° C. or lower, or 135° C. or lower, and for a time of, for example, 1 hour or longer, 2 hours or longer, or 3 hours or longer, and 12 hours or shorter, 10 hours or shorter, or 8 hours or shorter. The heating may be performed in one stage or multiple stages. In some embodiments, for example, two-stage heating is at 120° C. for 4 hours and at 135° C. for 2 hours.

In the following examples, a structure in which a volume fraction of carbon fibers with respect to a total volume of glass fibers and carbon fibers is 0% or 100% (when a fiber layer includes only a glass fiber layer or includes only a carbon fiber layer) may be referred to as a “non-hybrid component” and a structure in which the above volume fraction exceeds 0% and less than 100% (that is, when both a glass fiber layer and a carbon fiber layer are included as a fiber layer) may be referred to as a “hybrid component.” Furthermore, a volume fraction of carbon fibers with respect to a total volume of glass fibers and carbon fibers in the hybrid component may be referred to as a “hybrid ratio (symbol: μ).”

<Manufacture of hybrid component and non-hybrid component> Prepreg components used are as follows.

### [First Prepreg]

Type of reinforcement body: glass fibers
Type of prepreg: cloth component
Type of fibers: glass fibers (E-glass), tensile modulus E_{f}=75 GPa, and tensile strength σ_{T}=3.2 GPa
Fiber areal weight FAW: 290 g/m²
Fiber volume fraction V_{f}: 43.4 volume %
Type of resin which is impregnated: epoxy resin
Resin content RC: 40 mass %

### [Second Prepreg]

Type of reinforcement body: carbon fibers
Type of prepreg: cloth component
Type of fibers: carbon fibers (T300B), tensile modulus E_{f}=230 GPa, and tensile strength σ_{f}=3.53 GPa
Fiber areal weight FAW: 200 g/m²
Fiber volume fraction V_{f}: 46.5 volume %
Type of resin impregnated: epoxy resin
Resin content RC: 44 mass %

The above prepreg component was hand laid-up in a predetermined configuration so that an orientation of fibers between adjacent layers had a superposition of 0°/90° and a prepreg laminate was prepared. While a pressure of 0.490 MPa was applied to the prepreg laminate in an autoclave, heating at 120° C. for 4 hours and heating at 135° C. for 2 hours were performed in that order. Therefore, predetermined hybrid components of examples and predetermined non-hybrid components of comparative examples were manufactured.

Layer compositions of the predetermined hybrid components of Examples 1 to 3 and Comparative Examples 3 to 9 and the predetermined non-hybrid components of Comparative Examples 1 and 2 are shown in Table 1.

<Measurement of stress and strain curves> A test piece of 200 mm×10 mm was cut out from the components obtained above, and a testing machine gripping portion (tab portion) of 50 mm×10 mm×1 mm was adhered to both ends surfaces in a long axis direction using Aron Alpha (registered trademark, jelly like). In this case, a long axis of the test piece and a long axis of the tab portion were aligned and an adhesive length was set to 10 mm.

A strain gauge was attached to the above test piece in both horizontal and vertical directions, and a tensile test was performed using a universal material testing machine (commercially available from Shimadzu, Autograph, load cell: 50 kN) under the following conditions. Crosshead speed: 5 mm/min data capture: multi-input data collection systems NR-500, NR-U2, NR-HA08, and NR-ST04 commercially available from KEYENCE Corporation, and displacement detection: non-contact video displacement meter (DVE-201 commercially available from Shimadzu).

Measurement was performed at n=10 in Comparative Examples 1, 2, and 6 to 9 and at n=6 in Examples 1 to 3 and Comparative Examples 3 to 5. Values of the obtained breaking strain, tensile strength, and tensile modulus are shown in Table 1 as average values.

TABLE 1

| | | | | Evaluation results of structures | | | |
|---|---|---|---|---|---|---|---|
| | | | | Breaking strain | | | |
| | | | | | Relative | | |
| | Prepreg laminate | | | | value with | Tensile | Tensile |
| | | Hybrid | | | respect to | strength | modulus |
| | | ratio | | Measured | Comparative | Measured | Measured |
| | Layer | (volume | | value | Example 1 | value | value |
| | composition | fraction) | Abbreviation | (%) | (%) | (GPa) | (GPa) |
| Comparative | CF₄ | 1 | [C]₄ | 1.119 | 100.0 | 0.620 | 54.4 |
| Example 1 | | | | | | | |
| Comparative | GF₄ | 0 | [G]₄ | 2.850 | 254.7 | 0.453 | 20.4 |
| Example 2 | | | | | | | |
| Comparative | GF₅/CF₂/GF₅ | 0.176 | [G₅C]_{S} | 1.403 | 125.4 | 0.353 | 24.9 |
| Example 3 | | | | | | | |
| Comparative | GF₃/CF₂/GF₃ | 0.263 | [G₃C]_{S} | 1.414 | 126.4 | 0.373 | 27.4 |
| Example 4 | | | | | | | |
| Comparative | GF₂/CF₂/GF₂ | 0.349 | [G₂C]_{S} | 1.355 | 121.1 | 0.394 | 29.5 |
| Example 5 | | | | | | | |
| Comparative | GF/CF₂/GF | 0.517 | [GC]_{S} | 1.345 | 120.2 | 0.467 | 34.6 |
| Example 6 | | | | | | | |
| Comparative | GF/CF/GF/ | 0.517 | [GC]_{2S} | 1.360 | 121.5 | 0.454 | 34.4 |
| Example 7 | CF₂/GF/CF/GF | | | | | | |
| Comparative | GF₂/CF₄/GF₂ | 0.517 | [G₂C₂]_{S} | 1.373 | 122.7 | 0.462 | 34.6 |
| Example 8 | | | | | | | |
| Example 1 | GF/CF₄/GF | 0.682 | [GC₂]_{S} | 1.355 | 121.1 | 0.529 | 40.1 |
| Example 2 | GF/CF₆/GF | 0.763 | [GC₃]_{S} | 1.259 | 112.5 | 0.552 | 43.2 |
| Example 3 | GF/CF₁₀/GF | 0.843 | [GC₅]_{S} | 1.254 | 112.1 | 0.590 | 45.9 |
| Comparative | CF/GF₂/CF | 0.517 | [CG]_{S} | 1.214 | 108.5 | 0.409 | 34.2 |
| Example 9 | | | | | | | |

In the column of “layer composition” in Table 1, a first prepreg component (cloth component) containing glass fibers is referred to by the term of “GF” and a second prepreg component (cloth component) containing carbon fibers is referred to by the term of “CF.” For example, the expression “CFₙ” indicates that n layers of a CF prepreg were laminated and used when a component is manufactured.

The symbol “I” in the column of “layer composition” in Table 1 indicates that a laminate of components described before and after the symbol was laminated. For example, in Comparative Example 3 ([G₅C]ₛ), “GF₅/CF₂/GF₅” indicates a prepreg laminate in which five layers of a first prepreg component containing glass fibers, two layers of a second prepreg component containing carbon fibers, and five layers of a first prepreg component containing glass fibers were laminated in that order.

The prepreg laminates obtained in the examples and the comparative examples and the structures obtained from the prepreg laminates will be referred below to with the symbols shown in the column of “abbreviation” in Table 1.

It was confirmed that, when the structure was hybridized, the breaking strain increased more than in the structure in Comparative Example 1 which was a non-hybrid component.

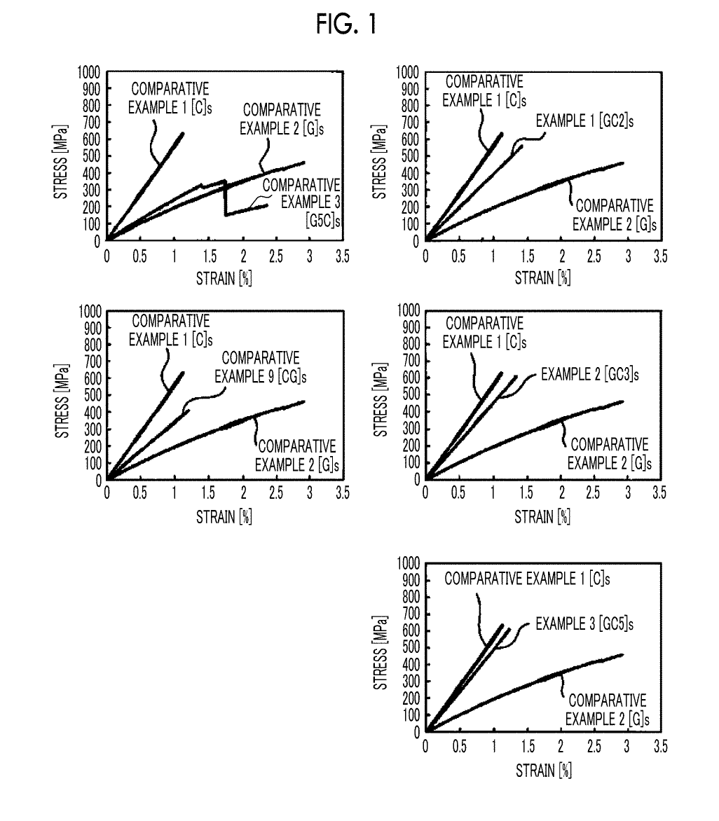

The stress and strain curves obtained in Comparative Example 3 ([G₅C]_{S}), Comparative Example 9 ([CG]_{S}), and Examples 1 to 3 ([GC₂]_{S}, [GC₃]_{S}, and [GC₅]_{S}) are shown in FIG. 1 in comparison with Comparative Example 1 ([C]₄) and Comparative Example 2 ([G]₄).

In Comparative Example 3 ([G₅C]_{S}) in which the percentage of glass fibers in the component was high, a serrated stress and strain curve was obtained, which was distinctive. It is conceivable that delamination occurred in addition to whitening due to breaking.

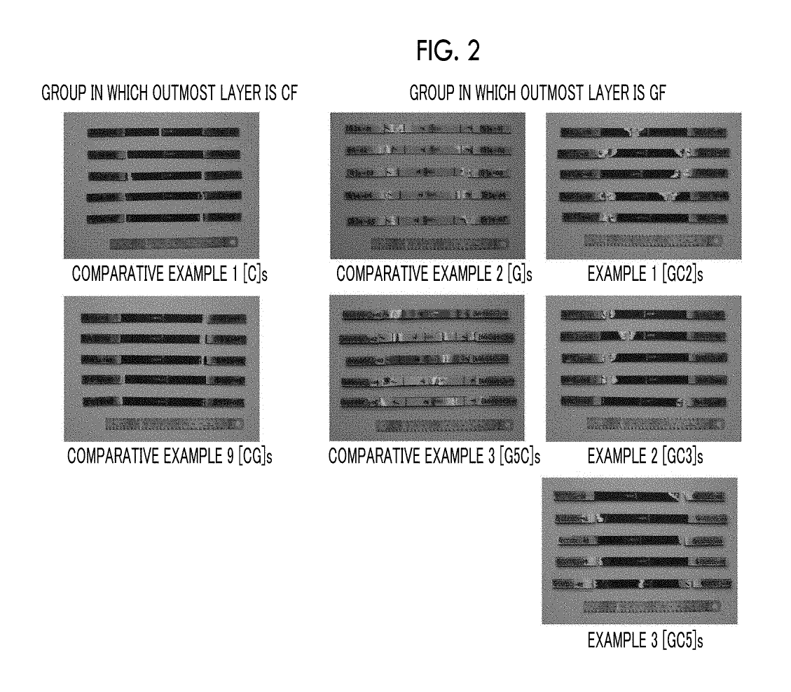

Pictures of samples that broke (each five pieces) after the tensile test in Comparative Examples 1 to 3 ([C]₄, [G]₄, and [G₅C]_{S}), Comparative Example 9 ([CG]_{S}), and Examples 1 to 3 ([GC₂]_{S}, [GC₃]_{S}, and [GC₅]_{S}) are shown in FIG. 2.

In Comparative Example 1 ([C]₄) and Comparative Example 9 ([CG]_{S}) (groups on the left side in FIG. 2), no clear destructive flaws that were visible were observed in the broken samples. This is considered to be caused by the fact that the component contained only carbon fibers or the outermost layer contained carbon fibers. On the other hand, in Comparative Example 2 ([G]₄), Comparative Example 3 ([G₅C]_{S}), and Examples 1 to 3 ([GC₂]_{S}, [GC₃]_{S}, and [GC₅]_{S}, groups on the right side in FIG. 2), whitening was observed in the broken samples. In particular, in Comparative Example 3 ([G₅C]_{S}), a serrated stress and strain curve was obtained in the tensile test. Therefore, it is considered that whitening due to delamination occurred in addition to whitening due to breaking.

<Evaluation of hybrid effect (increase from predicted values according to calculation)> Next, an effect of hybridization of glass fibers and carbon fibers was evaluated. Specifically, measured values of the tensile modulus and tensile strength obtained in the above tensile test were compared with predicted values according to calculation.

In a relationship of the tensile modulus, the tensile strength, and a hybrid ratio, prediction was performed based on measured values of non-hybrid components having a fiber volume fraction V_{f} of 60 volume %, and the result was compared with measured values.

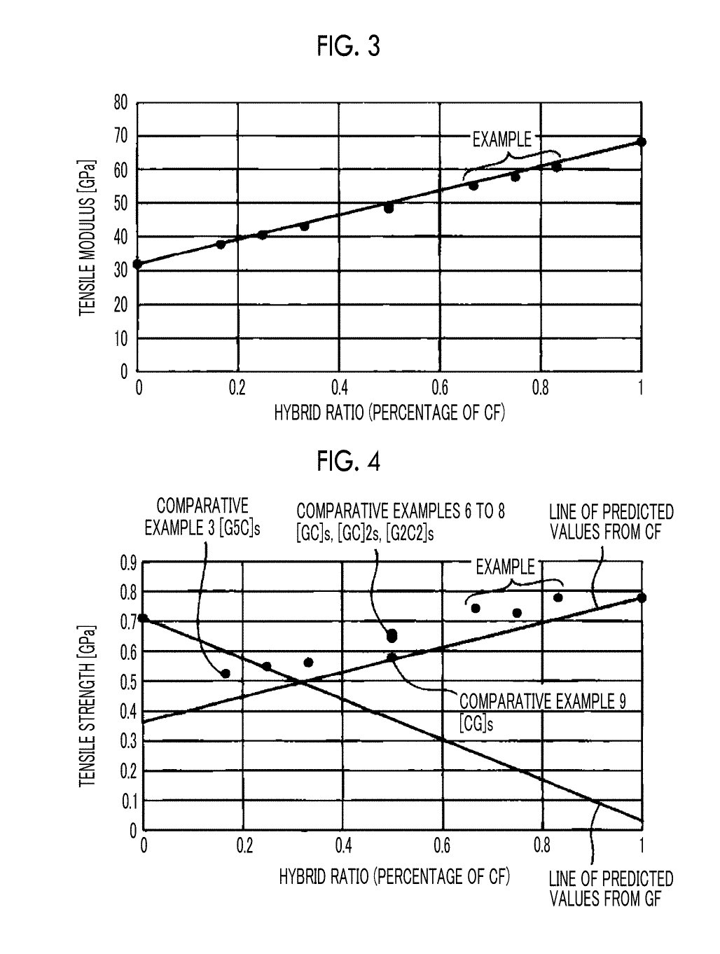

FIG. 3 is a graph showing a relationship between predicted values (a straight line) and measured values (plotted points) of the tensile modulus, and the horizontal axis represents a hybrid ratio.

In the tensile modulus, there was no significant difference between the predicted values and the measured values.

FIG. 4 is a graph showing a relationship between predicted values (a straight line) and measured values (plotted points) of the tensile strength, and the horizontal axis represents a hybrid ratio. For the predicted value, a predicted value from a second prepreg containing glass fibers and a predicted value from a second prepreg containing carbon fibers are shown together.

Referring to FIG. 4, in the tensile strength, it was confirmed that the measured values for the hybrid components were generally higher than the predicted values. However, in Comparative Example 3 ([G₅C]_{S}), the measured values were lower than the predicted values from the second prepreg.

In FIG. 4, comparing Comparative Example 6 ([GC]_{S}) and Comparative Example 9 ([CG]_{S}), when a prepreg containing glass fibers was disposed on the outermost layer of the component, the tensile strength was significantly higher than when a prepreg containing carbon fibers was disposed. However, since tensile strength values of Comparative Example 6 ([GC]_{S}), Comparative Example 7 ([GC]_{2S}), and Comparative Example 8 ([G₂C₂]_{S}) were not distinct from each other, when a prepreg containing glass fibers was disposed on the outermost layer, if the hybrid ratio was constant, influences of an increase and decrease in the number of layers and a change in layered structure were thought to be weak.

In the components of Examples 1 to 3 ([GC₂]_{S}, [GC₃]_{S}, and [GC₅]_{S}) that satisfied predetermined requirements of the present embodiment, the measured values were significantly greater than the predicted value from the second prepreg containing carbon fibers and a tensile strength comparable to that of 100% carbon fibers was shown.

<Supplements (composite rule regarding strength of hybrid component)> Prediction of a strength (tensile strength) of a hybrid component was performed with reference to “The strength of hybrid glass/carbon fibre composites Part. 1 Failure strain enhancement and failure mode,” J. Mater. Sci., 16(1981), 2233, (Manders et al.).

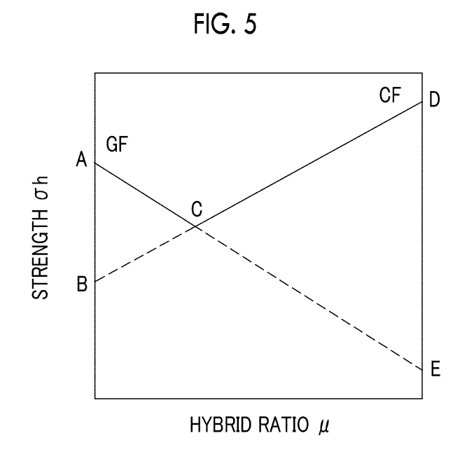

FIG. 5 is a graph showing predicted strength values when the horizontal axis represents a hybrid ratio μ expressed by a volume fraction. In FIG. 5, a predicted value from a first prepreg containing glass fibers is represented by the line segment ACE and a predicted value from a second prepreg containing carbon fibers is represented by the line segment BCD.

When strengths of structures obtained from the first prepreg alone and the second prepreg alone are represented by σ(GF) and σ(CF), respectively, and breaking strains of the structures are represented by ε(GF) and ε(CF), stresses at points A, B, and D are represented by σ(GF), σ(CF), and K·σ(GF), respectively. Here, K=ε(CF)/ε(GF).

Therefore, the line segments AC and CD are represented as follows.

σh=σ(GF)·(1−μ) AC:

σh=σ(GF)·μ+K·σ(GF)·(1−μ) CD:

In the above, μ indicates a volume fraction of carbon fibers with respect to a total volume of glass fibers and carbon fibers (=V(CF)/(V(CF)+V(GF)) and indicates a coordinate value in the horizontal axis in FIG. 4; σh indicates a strength and a coordinate value in the vertical axis.

When the above line segment AC was extrapolated to μ=1, the strength became zero. However, this was a result obtained assuming that the first prepreg and the second prepreg each were integrated, which did not match the reality. Therefore, carbon fibers, glass fibers, and a resin in the components were separately considered. A composite rule in which a total Vf=Vf(CF)+Vf(GF) of volume fractions of carbon fibers and glass fibers in the component was set to a constant value (=0.6), and a general composite component with an a and b2 component system was assumed was satisfied.

Thus, when a stress of a resin when glass fibers were cut is set as σm′, and when a stress of a resin when carbon fibers were cut is set as σm”, stresses at points A, B, and D are represented as follows.

σ(GF)=øf(GF)·Vf+σm’·(1−Vf) A:

σ(B)=K·σ(GF) B:

σ(CF)=σf(CF)·Vf+σm″·(1−Vf) D:

Here, a model including a resin with a volume fraction (1−Vf), glass fibers with a volume fraction (Vf(1−μ)), and voids with a volume fraction (Vf·μ) was considered. When extrapolation to μ=1 was performed in the line segment AE assuming that carbon fibers had no contribution to the stress, the following value (≠0) was obtained as a stress σE at the point E from the composite rule formula in the general composite component.

σf=σm′·(1−Vf) E:

What is claimed is:

1. A fiber reinforced polymer matrix composite structure comprising:
a glass fiber layer; and
a carbon fiber layer in a cured resin,
wherein the glass fiber layer and the carbon fiber layer are laminated and present in a thickness direction of the structure,
wherein two outermost layers of the fiber reinforced polymer matrix composite structure including the glass fiber layer and the carbon fiber layer are both the glass fiber layer, and
wherein, in the structure, a volume fraction of carbon fibers with respect to a total volume of glass fibers and carbon fibers is 0.67 or more.

2. A high pressure container comprising the fiber reinforced polymer matrix composite structure according to claim 1 on an outer circumferential surface of a liner.

3. A method of manufacturing the fiber reinforced polymer matrix composite structure according to claim 1 comprising:
laminating a first sheet prepreg containing glass fibers and a second sheet prepreg containing carbon fibers to prepare a prepreg laminate; and
heating the prepreg laminate,
wherein two outermost layers in the prepreg laminate are both the first sheet prepreg, and
wherein, in the prepreg laminate, a volume fraction of carbon fibers with respect to a total volume of glass fibers and carbon fibers is 0.67 or more.

4. A method of manufacturing the high pressure container according to claim 2, comprising:
sheet-winding a first sheet prepreg containing glass fibers and a second sheet prepreg containing carbon fibers on an outer circumference of the liner to form a prepreg laminate on the outer circumference of the liner;
helically winding carbon fibers on the prepreg laminate to obtain a high pressure container precursor; and
heating the high pressure container precursor,
wherein two outermost layers in the prepreg laminate are both the first sheet prepreg, and
wherein, in the prepreg laminate, a volume fraction of carbon fibers with respect to a total volume of glass fibers and carbon fibers is 0.67 or more.
